(19) United States
(12) Patent Application Publication
(10) Pub. No.: US 2014/0278469 A1
(43) Pub. Date: Sep. 18, 2014

(54) SYSTEMS AND METHODS FOR TRACKING AND DESIGNING CLINICAL TRIALS

(71) Applicant: Angelo Secci, Levittown, PA (US)

(72) Inventor: Angelo Secci, Levittown, PA (US)

(73) Assignee: Otsuka Pharmaceutical Co.ltd., Tokyo (JP)

(21) Appl. No.: 13/838,348

(22) Filed: Mar. 15, 2013

(51) Int. Cl. G06F 19/00

(52) U.S. Cl. CPC G06F 19/363
USPC 705/2

(57) ABSTRACT

Systems, apparatuses, and methods are provided for planning, activating, analyzing, and monitoring clinical trials. A planning process gathers clinical trial initiation parameters and produces a clinical trial plan. An activation process prepares and activates clinical sites in various countries to screen, enroll, and provide clinical trial drugs or devices to subjects. An analysis process tracks the rate at which trial completion objectives are completed and models progress scenarios (e.g., best case, worst case, base, etc.) and potential outcomes. Finally, a monitoring process allows a clinical trial manager to monitor the progress of the clinical trial and modify the clinical trial plan as needed to meet trial completion objectives.

### FIELD

The disclosed embodiments generally relate to clinical trials in the pharmaceutical and biotechnology industries and, more particularly, to systems, methods, and articles of manufacture for designing and tracking clinical trials for new therapies.

### BACKGROUND

The pharmaceutical and biotechnology industries are structured in a unique manner. Huge amounts of time, money, and other resources are poured into research and development projects for new products and therapies. The stakes are high, but so are the potential rewards; the top-selling drugs and medical products could reap billions of dollars of profit each year for the companies who develop them.

Unlike other industries which are often limited in their production only by their own resources and supply chain, the pharmaceutical and biotechnology industries also must take into account the safety and efficacy of their products. These concerns are a key focus of governmental and regulatory agencies worldwide.

Thus, the so-called “clinical trial” is an essential part of the business of a firm in these industries. Years of research and billions of dollars may be riding on a successful trial. The trials themselves are complex in their own right—with an avalanche of paperwork, deadlines, and medical records to keep up with, as well as thousands of test subjects all over the world, efficient organization, implementation and monitoring of the clinical trial process is vital to success.

It is accordingly an object to overcome the shortcomings of current techniques for planning, implementing, and monitoring clinical trials.

### SUMMARY

In one embodiment, a computer-implemented method is disclosed for conducting a clinical trial including multiple clinical trial sites. The method includes receiving progress data for the clinical trial, and creating database entries in a database based on the progress data. Additionally, the method includes determining projection ratios of clinical trial subjects screened, enrolled, and randomized at each clinical trial site based on the database entries. The method further includes modeling a projected outcome of the clinical trial based on the database entries and the determined ratios. Further, the method includes supplementing the database entries based on the progress data with additional data received from one or more of the clinical trial sites, and updating the modeled potential outcome via a user interface linked to the database based on the additional data. The method additionally comprises adjusting, via a user interface linked to the database, the number of clinical trial sites in the clinical trial based on the ratios and the updated modeled scenario.

In another embodiment, a computer-implemented method is disclosed for conducting a clinical trial including multiple clinical trial sites in multiple countries. The method includes establishing a plan for the clinical trial that comprises a time period, a target number of clinical trial subjects to be randomized in the clinical trial, and a list of one or more countries in which the clinical trial will be conducted. As part of the method, the clinical trial plan is stored in a database. Additionally, the method includes activating, via a user interface linked to the database, one or more clinical trial sites for the clinical trial to enable the activated sites to begin screening subjects. The method further includes receiving first progress data for the clinical trial from one or more clinical trial sites, and creating database entries in a database based on the first progress data. Further, the method includes determining ratios based on the database entries, the ratios corresponding to the number of clinical trial subjects screened, enrolled, and randomized per activated clinical trial site per month. The method additionally comprises receiving updated progress data from one or more of the activated clinical trial sites, and supplementing the database entries based on the updated progress data. The method further includes monitoring the clinical trial based on the first progress data and the updated progress data, and modifying the clinical trial plan in the database based on the monitoring.

In another embodiment, a computer-implemented method is disclosed for conducting a clinical trial including multiple clinical trial sites in multiple countries. The method includes establishing a plan for the clinical trial, wherein the plan comprises a number of countries required for successful completion of the clinical trial and a number of clinical trial sites within each country, and storing the plan for the clinical trial in a database. Additionally, the method includes activating, via a user interface linked to the database, one or more countries required for successful completion of the clinical trial based on the clinical trial plan. The method further includes activating, via a user interface linked to the database, one or more clinical trial sites within each country based on the clinical trial plan to enable to the activated sites to begin screening subjects. Further, the method includes receiving progress data from one or more clinical trial sites, and creating database entries in the database based on the received progress data. The method additionally comprises modeling a potential outcome of the clinical trial based on the database entries, and modifying the clinical trial plan based on the modeled potential outcome.

In yet another embodiment, a system is disclosed for conducting a clinical trial including multiple clinical trial sites. The system comprises a memory containing instructions, and one or more processors configured to execute the instructions to receive progress data for the clinical trial, and create database entries in a database based on the progress data. Additionally, the one or more processors are further configured to determine projection ratios of clinical trial subjects screened, enrolled, and randomized at each clinical trial site based on the database entries. The one or more processors are further configured to execute the instructions to model a projected outcome of the clinical trial based on the database entries and the determined ratios. Further, the one or more processors are further configured to execute the instructions to supplement the database entries based on the progress data with additional data received from one or more of the clinical trial sites, and update the modeled potential outcome via a user interface linked to the database based on the additional data. The one or more processors are additionally configured to execute the instructions to adjust, via a user interface linked to the database, the number of clinical trial sites in the clinical trial based on the ratios and the updated modeled scenario.

In yet another embodiment, a clinical trial manager system is disclosed for conducting a clinical trial. The system comprises a memory containing instructions, and one or more processors configured to execute the instructions to receive progress data for the clinical trial from a plurality of clinical trial sites, and determine one or more projection ratios of clinical trial subjects screened, enrolled, and/or randomized by at least one of the clinical sites based on the received progress data. Additionally, the one or more processors are further configured to make a projection of the clinical trial based on the received progress data and the one or more projection ratios. The one or more processors are further configured to store the one or more projection ratios and the projection in the memory. Finally, the one or more processors are further configured to execute the instructions to model a scenario of the clinical trial by reviewing at least one of the one or more projection ratios or the projection stored in the memory

### BRIEF DESCRIPTION OF THE DRAWINGS

The accompanying drawings, which are incorporated in and constitute a part of this specification, illustrate various embodiments and aspects of the disclosed embodiments and, together with the description, serve to explain the principles of the disclosed embodiments. In the drawings:

FIG. 1 illustrates an exemplary system environment consistent with certain disclosed embodiments;

FIG. 2 illustrates an exemplary clinical trial manager system consistent with certain disclosed embodiments;

FIG. 3 is a flowchart of an exemplary clinical trial design and tracking process consistent with certain disclosed embodiments;

FIG. 4 is a flowchart of an exemplary clinical trial planning process consistent with certain disclosed embodiments;

FIG. 5 is a flowchart of an exemplary clinical trial activation process consistent with certain disclosed embodiments;

FIG. 6 is a flowchart of an exemplary clinical trial analysis process consistent with certain disclosed embodiments;

FIG. 7 is a flowchart of an exemplary gap calculation process consistent with disclosed embodiments;

FIG. 8 is a flowchart of an exemplary scenario modeling process consistent with certain disclosed embodiments;

FIG. 9 is a flowchart of an exemplary clinical trial monitoring process consistent with certain disclosed embodiments; and

FIG. 10 is a flowchart of an exemplary trial modification process consistent with certain disclosed embodiments.

### DETAILED DESCRIPTION

Reference will now be made in detail to the disclosed exemplary embodiments, examples of which are illustrated in the accompanying drawings. Wherever possible, the same reference numbers will be used throughout the drawings to refer to the same or like parts.

Methods, systems, and articles of manufacture relating to the disclosed embodiments provide features for planning, designing, activating, monitoring, and modifying clinical trials, particularly in the pharmaceutical and life sciences industries.

In a clinical trial, “screening” may refer to a process of interviewing prospective clinical trial subjects to determine their eligibility for the clinical trial. “Enrolling” may refer to the intake process for subjects for the clinical trial, which may be performed at various clinical sites. Enrolled subjects will typically have passed the “screening” stage of the clinical trial process at the time of enrollment. “Randomizing” in a clinical trial may refer to a process of separating enrolled clinical trial subjects into experimental groups for part or all of the clinical trial. Consistent with principles of the scientific method, subjects may be randomly placed into experimental groups, with some receiving the active product and others receiving a placebo. The randomization process is usually done in a double-blind manner, but it need not always be so. Randomization is usually one key metric for a clinical trial manager; in some trials, a certain number of trial subjects must be “randomized” by a certain date for the trial to be a technical success. All randomized subjects will typically have passed the “screening” and “enrollment” stages of the clinical trial process at the time of randomization.

Reaching the proper target enrollment is important from an ethical point of view because of the risks inherent to overenrolling. Potentially exposing subjects in numbers more than necessary and/or more than approved by regulators and Institutional Review Boards (IRBs) should be avoided or minimized as much as possible. Large and complex trials have a large inertia in regard to stopping enrollment and the ability to forecast when the target enrollment number will be reached is a fundamental step in this process. Properly forecasting and planning the clinical trial is also relevant form a financial point of view. Managing a trial and managing sites participating in a trial is one of the major cost drivers in exceeding the budget for each given trial and these costs are driven by the tight time constraints. The ability to model an efficient clinical trial from this point of view may result in significant financial savings. A final aspect of properly planning a trial is connected with internal and external human resources (personnel) allocation. If the proper personnel is not available or not properly allocated the trail may fail from a technical and scientific point of view as a result of inappropriate oversight or untimely conduct of certain tasks associated with the planning, conduct, and monitoring of the trial itself. Proper forecasting of the workload is closely connected to enrollment and completion times. Being able to properly forecast the various timelines of a trial allows for human resources optimization resulting in an overall increased chance of technical and scientific success.

FIG. 1 illustrates an exemplary system environment 100 consistent with disclosed embodiments. In one aspect, system environment 100 may include clinical trial manager 105, clinical trial manager system 110, database 120, clinical sites 125-1 through 125-N, clinical site systems 130-1 through 130-N, and network 140.

Clinical trial manager 105 may represent one or more entities or people associated with the clinical trial. Clinical trial manager 105 may be an individual, a group of individuals, a business entity, or a group of business entities. Although the description of certain embodiments may refer to an “individual,” the description applies to a group of users or a business entity. In certain aspects, clinical trial manager 105 may further comprise one or more clinical trial manager systems 110 used by clinical trial manager 105 to perform computing activities, which will be described in further detail below. In one embodiment, clinical trial manager 105 may be employed by or affiliated with the entity responsible for the product associated with the clinical trial. In another embodiment, clinical trial manager 105 may be employed by or affiliated with a service provider conducting the clinical trial.

Consistent with the disclosure, clinical trial manager system 110 may perform various functions associated with clinical trial manager 105 and the clinical trial in general. Clinical trial manager system 110 will be discussed in further detail in association with FIG. 2 below. Briefly, in some embodiments, clinical trial manager system 110 may receive and process data and information from clinical sites associated with the clinical trial, such as clinical sites 130-1 through 130-N. Clinical trial manager system 110 is capable of performing various functions to provide planning, activation, and monitoring of all phases of a clinical trial.

Clinical trial manager system 110 may include one or more components that perform processes consistent with the disclosed embodiments. For example, clinical trial manager system 110 may include one or more computers (e.g., servers, database systems, etc.) configured to execute software instructions programmed to perform aspects of the disclosed embodiments, such as planning clinical trials, activating clinical trials, analyzing clinical trials, monitoring clinical trials, etc.

Database 120 may represent one or more storage devices and/or systems that maintain data used by elements of system environment 100. Database 120 may include one or more processing components (e.g., storage controller, processor, etc.) that perform various data transfer and storage operations consistent with certain features consistent with the disclosed embodiments. In certain embodiments, database 120 may be associated with clinical trial manager system 110, and may be implemented as a component of clinical trial manager system 110 either remotely or locally, or may be part of clinical trial manager system 110. In other embodiments, database 120 may be related to other entities, such as clinical sites 125-1 through 125-N. In other aspects, database 120 may be related to an independent entity that provides database services for one or more components of system environment 100 consistent with the disclosed embodiments.

Database 120 may store data associated with a clinical trial that may be submitted from any of clinical trial manager system 110 or clinical site systems 130-1 through 130-N. Database 120 may store a plan for a clinical trial that may be established, updated, and implemented by clinical trial manager system 110 or clinical site systems 130-1 through 130-N. Database 120 may store initiation parameters for the clinical trial; calculated clinical trial projection data based on data received from clinical trial manager system 110 and/or clinical site systems 130-1 through 130-N; and/or data and information associated with clinical trial scenarios modeled by clinical trial manager system 110. These and other components of system environment 100 may be configured to interface with database 120 via network 140 or other communication mechanisms.

Clinical sites 125-1, 125-2, 125-N, etc. may represent one or more entities or people associated with the management and operation of clinical sites associated with the clinical trial. Clinical sites 125 may be managed by an individual, a group of individuals, a business entity, or a group of business entities. Although the description of certain embodiments may refer to an “individual,” the description applies to a group of users or a business entity. In certain aspects, clinical sites 125 may further comprise one or more clinical site systems 130-1, 130-2, 130-N, etc. used by clinical sites 125-1, 125-2, 125-N, etc. to perform computing activities, which will be described in further detail below. In one embodiment, clinical sites 125 may be affiliated with the entity responsible for the product associated with the clinical trial. In another embodiment, clinical sites 125 may be affiliated with a service provider conducting the clinical trial.

Clinical sites 125-1, 125-2, 125-N, etc. may represent one or more entities that provide services associated with a clinical trial. In one embodiment, these services may comprise screening, enrolling, and randomizing clinical trial subjects. For example, clinical sites 125 may represent medical facilities that screen potential clinical trial subjects based on medical history, physical examinations, other predetermined criteria, etc. Clinical sites 125 may dispense drugs, devices, or products associated with a clinical trial to clinical trial subjects, for example, as part of the randomization phase of the trial. Clinical sites 125 may be locations owned by the entity responsible for the clinical trial, or may be independent. Clinical sites 125 may be located in any country. Each clinical site 125 may contain various computing systems and/or other components that may allow it to communicate with clinical trial manager system 110, or with other clinical sites 125, as will be described below.

Consistent with the disclosure, clinical site systems 130-1 through 130-N may perform various functions associated with clinical sites 125-1 through 125-N and the clinical trial in general. In some embodiments, clinical site systems 130 may receive and process data and information from clinical trial manager system 110, and from other clinical site systems 130. Clinical site systems 130 are capable of performing various functions to provide planning, activation, and monitoring of all phases of a clinical trial.

Clinical site systems 130 may include one or more components that perform processes consistent with the disclosed embodiments. For example, clinical site systems 130 may include one or more computers (e.g., servers, database systems, etc.) configured to execute software instructions programmed to perform aspects of the disclosed embodiments, such as monitoring clinical trials, processing clinical trial data, processing documents associated with the clinical trial, etc.

Consistent with disclosed embodiments, components of system 100, including clinical trial manager system 110 and clinical site systems 130, may include one or more processors (such as processors 111, 131, 133, or 135) as shown in exemplary form in FIG. 1. The processors may be one or more known processing devices, such as a microprocessor from the Pentium™ family manufactured by Intel™ or the Turion™ family manufactured by AMD™. The processor may include a single core or multiple core processor system that provides the ability to perform parallel processes simultaneously. For example, the processors may be single core processors configured with virtual processing technologies known to those skilled in the art. In certain embodiments, the processors may use logical processors to simultaneously execute and control multiple processes. The processors may implement virtual machine technologies, or other similar known technologies to provide the ability to execute, control, run, manipulate, store, etc. multiple software processes, applications, programs, etc. In some embodiments, the processors may include a multiple-core processor arrangements (e.g., dual or quad core) configured to provide parallel processing functionalities to enable computer components of clinical trial manager system 110 and/or clinical site systems 130 to execute multiple processes simultaneously. Other types of processor arrangements could be implemented that provide for the capabilities disclosed herein. Moreover, the processors may represent one or more servers or other computing devices that are associated with clinical trial manager system 110 and/or clinical site systems 130. For instance, the processors may represent a distributed network of processors configured to operate together over a local or wide area network. Alternatively, the processors may be a processing device configured to execute software instructions that receive and send information, instructions, etc. to/from other processing devices associated with clinical trial manager system 110 or other components of system 100. In certain aspects, processors 111, 131, 133 and/or 135 may be configured to execute software instructions stored in memory to perform one or more processes consistent with disclosed embodiments.

Consistent with disclosed embodiments, components of system 100, including clinical trial manager system 110 and clinical site systems 130, may also include one or more memory devices (such as memories 112, 132, 134, and 136) as shown in exemplary form in FIG. 1. The memory devices may store software instructions that are executed by processors 111, 131, 133, and 135, respectively, such as instructions associated with one or more applications, network communication processes, operating system software, software instructions relating to the disclosed embodiments, and any other type of application or software known to be executable by processing devices. The memory devices may be volatile or non-volatile, magnetic, semiconductor, tape, optical, removable, nonremovable, or other types of storage devices or tangible computer-readable media. The memory devices may be two or more memory devices distributed over a local or wide area network, or may be a single memory device. In disclosed embodiments, the memory devices may include database systems, such as database storage devices, configured to receive instructions to access, process, and send information stored in the storage devices.

In some embodiments, clinical trial manager 105, clinical trial manager system 110, clinical sites 125, and clinical site systems 130 may also include one or more additional components (not shown) that provide communications with other components of system environment 100, such as through network 140, or any other suitable communications infrastructure.

Network 140 may be any type of network that facilitates communications and data transfer between components of system environment 100, such as, for example, clinical trial manager 105, clinical trial manager 110, database 120, clinical sites 125, and clinical site systems 130-1 through 130-N. Network 140 may be a Local Area Network (LAN), a Wide Area Network (WAN), such as the Internet, and may be a single network or a combination of networks. Further, network 140 may reflect a single type of network or a combination of different types of networks, such as the Internet and public exchange networks for wireline and/or wireless communications. Network 140 may utilize cloud computing technologies. Moreover, any part of network 140 may be implemented through infrastructures or channels of trade to permit operations associated with financial accounts that are performed manually or in-person by the various entities illustrated in FIG. 1. Network 140 is not limited to the above examples and system 100 may implement any type of network that allows the entities (and others not shown) included in FIG. 1 to exchange data and information.

Although FIG. 1 describes a certain number of entities and processing/computing components within system 100, any number or combination of components may be implemented without departing from the scope of the disclosed embodiments. For example, different clinical trial managers 105 may interact with one or more clinical trial manager systems 110 through network 140. In another example, different clinical trial manager systems 110 may interact with one or more clinical site systems 130 through network 140 or standard channels of trade. Additionally, clinical trial manager system 110 and clinical site systems 130 are not mutually exclusive. For example, in one disclosed embodiment, clinical trial manager system 110 and one or more clinical site systems 130 may be or may be associated with the same entity. Clinical sites 125 are not mutually exclusive; for example, clinical site 125-1 and clinical site 125-2 may be the same entity, different locations of the same entity, subsidiaries of the same entity, or a parent entity and its subsidiary. Thus, the entities as described are not limited to their discrete descriptions above. Further, where different components of system environment 100 are combined (e.g., clinical site 125-1 and clinical site 125-2, etc.), the computing and processing devices and software executed by these components may be integrated into a local or distributed system.

FIG. 2 illustrates an exemplary clinical trial manager system 110, consistent with disclosed embodiments. In one aspect, clinical trial manager system 110 may include user interface 201, modeling tool 202, ratio calculator block 203, gap calculator block 204, clinical trial monitoring unit 206, and clinical trial activation unit 207.

User interface 201 may permit interaction of clinical trial manager 105 with the components of clinical trial manager system 110. Modeling tool 202 may permit clinical trial manager system 110 to process real-time clinical trial data, such as that received from clinical sites 130, and generate projections, reports, model scenarios, and other information relevant to the decision-making processes of clinical trial manager 105. Modeling tool 202 may possess the capability to produce outputs, such as charts, graphs, reports, or database entries.

Ratio calculator 203 may process clinical trial progress data received from clinical sites 130-1 through 130-N to assist clinical trial manager 105 in monitoring the progress of the clinical trial. Ratio calculator 203 may produce updates on the progress of the clinical trial, prompt clinical trial manager 105 for action, etc. For example, ratio calculator 203 may review, compute, and report the numbers of clinical trial subjects screened, enrolled, and randomized at any or all clinical sites in any or all countries associated with the clinical trial, and present those numbers into a format that enables clinical trial manager 105 to review and take appropriate action if necessary.

Gap calculator 204 may compare clinical trial progress data with various hypothetical projections and scenarios, e.g., produced by other components of clinical trial manager system 110 and other components of system environment 100. Due to regression from the mean, clinical trial progress data may not always reflect the true status of the clinical trial. For example, a particularly productive month randomizing test subjects at a given clinical site may bias computerized projections. Gap calculator 204 may determine that such a biasing error has occurred and notify clinical trial manager 105, take steps to correct the error itself, etc.

Clinical trial monitoring unit 206 enables clinical trial manager 105 to perform processes related to monitoring the progress of the clinical trial. Clinical trial monitoring unit 206 may interact with other components of clinical trial manager system 110 and other elements of system environment 100 to serve as an electronic set of eyes for clinical trial manager 105. As an example, clinical trial monitoring unit 206 may receive clinical trial progress data from database 120, and compare the data to projections made by ratio calculator 203 and scenarios modeled by modeling tool 202. If the clinical trial progress data does not meet or exceed the pace of screening, enrollment, and randomization as prescribed by a clinical trial plan, clinical trial monitoring unit 206 may perform various modifications to the clinical trial in concert with, for example, clinical trial activation unit 207, which will now be described.

Clinical trial activation unit 207 enables clinical trial manager 105 to perform processes related to activating countries associated with the clinical trial, and individual clinical sites, such as clinical sites 125-1 through 125-N, within those countries. In one embodiment, clinical trial activation unit 207 may draft, transmit, and/or process documents necessary for the clinical trial. In one embodiment, clinical trial activation unit 207 may create database linkages and database entries for countries associated with the clinical trial, and individual clinical sites, such as clinical sites 125-1 through 125-N, within those countries when activation of those countries/sites is to occur. Clinical trial activation unit 207 may interact with other components of clinical trial manager system 110 and system environment 100 to monitor and update the activation status of countries associated with the clinical trial, and clinical sites, such as clinical sites 125-1 through 125-N, within those countries. Clinical trial activation unit 207 may interact with clinical trial monitoring unit 206, and on prompting from clinical trial monitoring unit 206, may activate or shut down countries or sites in order to meet goals relating to time, budget, and/or performance of the clinical trial.

As disclosed, the components, processes, and embodiments herein enable the entities of system 100 to design, implement, and monitor clinical trials. FIG. 3 is a flowchart of an exemplary clinical trial design and tracking process 300 consistent with disclosed embodiments. In certain embodiments, clinical trial manager system 110 and clinical site systems 130-1 through 130-N may execute software instructions to perform the clinical trial design and tracking process of FIG. 3. As an example, FIG. 3 is disclosed in connection with clinical trial manager system 110 performing the process of FIG. 3. Each step of process 300 will be described later in further detail.

In one aspect, processor 111 executes software instructions from memory 112 to perform a clinical trial planning process (Step 310). In short, as part of the clinical trial planning process, clinical trial manager system 110 may determine various pieces of data and parameters that are necessary to commence the clinical trial., such as the number of clinical trial subjects required for successful completion of the trial, countries where the clinical trial will be conducted, and the number of clinical trial screening sites required in each country for the clinical trial. The clinical trial planning process of Step 310 will be discussed in further detail below in connection with FIG. 4.

Clinical trial manager system 110 may perform a clinical trial activation process (Step 320). In short, as part of the clinical trial activation process, clinical trial manager system 110, via clinical trial activation unit 207, may complete various steps necessary to activate clinical sites 125-1 through 125-N for purposes of carrying out a clinical trial. Activation may require, for example, transmitting and receiving activation documents, activating the clinical trial screening sites, performing site initiation visits, and commencing screening of clinical trial subjects. The clinical trial activation process of Step 320 will be discussed in further detail below in connection with FIG. 5.

Clinical trial manager system 110 may perform a clinical trial analysis process (Step 330). In short, as part of the clinical trial analysis process, clinical trial manager system 110, via processor 111, modeling tool 202, gap calculator 203, and/or ratio calculator 204, may receive data such as the number of clinical trial subjects screened, the number of clinical trial subjects enrolled, and the number of clinical trial subjects randomized into the clinical trial from clinical sites 125-1 through 125-N. Clinical trial manager system 110 may then use the received data to plan, implement, and assess the performance of the clinical trial. The clinical trial activation process of Step 330 will be discussed in further detail below in connection with FIGS. 6-8.

Clinical trial manager system 110 may perform a clinical trial monitoring process (Step 340). In short, as part of the clinical trial monitoring process, clinical trial manager system 110, via processor 111 and clinical trial monitoring unit 206, may monitor and, as needed, modify the clinical trial. The clinical trial monitoring process of Step 340 will be discussed in further detail below in connection with FIGS. 9-10.

FIG. 4 is a flowchart of an exemplary clinical trial planning process 400 consistent with certain disclosed embodiments. Clinical trial planning process 400, as well as any or all of the individual steps therein, may be performed by any one or more of clinical trial manager 105, clinical trial manager system 110, clinical sites 125-1 through 125-N, and clinical site systems 130-1 through 130-N. For exemplary purposes, FIG. 4 is disclosed as being performed by clinical trial manager system 110.

In one embodiment, clinical trial manager system 110 may record the current date (Step 410). The current date may be taken from any number of sources known in the art. In multinational clinical trials, there may be more than one current date recorded. In addition, the current date may optionally be stored by one or more entities of exemplary system environment 100, either in a memory device configured for that entity, or in database 120.

Clinical trial manager system 110 may determine the number of subjects required for successful completion of the clinical trial (Step 420). In one aspect, the determination may be made based on extrapolations from previous clinical trials of similar size and characteristics. In another aspect, the number of subjects required may be dictated by regulatory authorities or governmental entities. In another aspect, the number of subjects required may be updated after the trial begins. In addition, the number of subjects required for the clinical trial may optionally be stored as a trial parameter by one or more entities of exemplary system environment 100, either in a memory device configured for that entity, or in database 120.

Clinical trial manager system 110 may determine the countries in which the clinical trial will be conducted (Step 430). In one aspect, the determination may be made based on prior experience from previous clinical trials of similar size and characteristics. In another aspect, the countries in which the clinical trial will be conducted may be dictated by regulatory authorities or governmental entities. In another aspect, the countries in which the trial will be conducted may be updated after the trial begins. Factors that may affect countries in which the clinical trial will be conducted may include cost, demographics, market considerations for future projects, infrastructure, tax considerations, governmental restrictions, etc. In addition, the countries in which the clinical trial will be conducted may optionally be stored as a trial parameter by one or more entities of exemplary system environment 100, either in a memory device configured for that entity, or in database 120.

Clinical trial manager system 110 may determine the number of subjects from each country associated with the trial that are required for successful completion of the clinical trial (Step 440). In one aspect, the determination may be made based on extrapolations from previous clinical trials of similar size and characteristics. In another aspect, the number of subjects required from each country may be dictated by regulatory authorities or governmental entities. In another aspect, the number of subjects required from each country may be updated after the trial begins. In addition, the number of subjects required from each country may optionally be stored as a trial parameter by one or more entities of exemplary system environment 100, either in a memory device configured for that entity, or in database 120.

Clinical trial manager system 110 may determine the number of clinical sites, such as clinical sites 125-1 through 125-N, required in each country for successful completion of the clinical trial (Step 450). In one aspect, the determination may be made based on extrapolations from previous clinical trials of similar size and characteristics. In another aspect, the number of clinical sites required in each country may be dictated by regulatory authorities or governmental entities. In another aspect, the number of clinical sites required in each country may be updated after the trial begins. Factors that may influence the number of clinical sites required in each country may include cost, demographics, market considerations for future projects, infrastructure, tax considerations, governmental restrictions, etc. In addition, the number of clinical sites required in each country may optionally be stored as a trial parameter by one or more entities of exemplary system environment 100, either in a memory device configured for that entity, or in database 120.

Clinical trial manager system 110 may determine the start date for the clinical trial (Step 460). In one aspect, the determination may be made based on extrapolations from previous clinical trials of similar size and characteristics. In another aspect, the start date may be dictated by regulatory authorities or governmental entities. The start date may account for the capacity of clinical sites 125-1 through 125-N to screen patients, the availability of the clinical trial drug or device, or other factors. In addition, the start date may optionally be stored as a trial parameter by one or more entities of exemplary system environment 100, either in a memory device configured for that entity, or in database 120.

Clinical trial manager system 110 may create a clinical trial plan (Step 470). The plan may comprise the other parameters assembled and described previously in Steps 410-460, along with additional information, manual inputs from clinical trial manager 105, etc. The clinical trial plan may, for example, contain the target date for completion of the trial, the number of subjects that must be randomized, and the number of countries and clinical sites that will be required to achieve the goals. The clinical trial plan may specify personnel that will be assigned to the project. The clinical trial plan may be stored in database 120, and transmitted, shared, and updated freely by members of system environment 100.

FIG. 5 is a flowchart of an exemplary clinical trial activation process 500 consistent with certain disclosed embodiments. Clinical trial activation process 500, as well as any or all of the individual steps therein, may be performed by any one or more of clinical trial manager 105, clinical trial manager system 110, clinical sites 125-1 through 125-N, and clinical site systems 130-1 through 130-N. For exemplary purposes, FIG. 5 is disclosed as being performed by clinical trial manager system 110.

Clinical trial manager system 110, via clinical trial activation unit 207, may execute software instructions to load clinical trial planning data (Step 510). In one aspect, clinical trial manager system 110 may retrieve the clinical trial planning data from memory 112, or from another component in system environment 100, such as database 120. Further, clinical trial manager system 110 may be configured to receive the clinical trial planning data from clinical site systems 130-1 through 130-N directly, e.g., via telephonic or postal means, or via network 140 using communication means known in the art. The clinical trial planning data may include, for example, the parameters assembled and documented during the clinical trial planning process, and may also comprise the clinical trial plan.

Clinical trial manager system 110, via clinical trial activation unit 207, may transmit clinical site activation documents to clinical sites associated with the clinical trial, for example, some or all of clinical sites 125-1 through 125-N via clinical site systems 130-1 through 130-N (Step 520). Clinical trial manager system 110 may transmit the documents to clinical sites 125 directly, e.g., via telephonic or postal means, or via network 140 using communication means known in the art. In one aspect, the clinical site activation documents may comprise certification of facilities, certification of staff members, governmental or regulatory documents, or any other required documents necessary for activation of clinical trial sites.

Clinical trial manager system 110, via clinical trial activation unit 207, may be configured to receive completed clinical site activation documents from clinical sites 125 associated with the clinical trial via clinical site systems 130 (Step 530). Clinical trial manager system 110 may receive the completed activation documents from clinical site systems 130 directly, e.g., via telephonic or postal means, or via network 140 using communication means known in the art.

Clinical trial manager system 110, via clinical trial activation unit 207, may be configured to activate clinical sites associated with the clinical trial once completed site activation documents are received; for example, clinical sites 125-1 through 125-N (Step 540). As part of the activation, database entries may be created, entered, and updated for the newly-activated sites in database 120, and automatic monitoring and updating of these sites may be implemented via clinical trial monitoring unit 206. Clinical trial manager system 110 may electronically activate clinical sites 125 via user interface 201 linked to database 120. Activation notices may be sent to clinical sites 125 directly, e.g., via telephonic or postal means, or via network 140 using communication means known in the art.

Clinical trial manager 105 may perform a site initiation visit to any or all of clinical sites 125-1 through 125-N (Step 550). In one aspect, the visit may be performed in person by clinical trial manager 105. In another aspect, the visit may be performed virtually via clinical trial manager system 110, utilizing user interface 201, clinical trial activation unit 207 and network 140 to perform the visit remotely.

Clinical trial manager system 110 may transmit commands to clinical sites, such as clinical sites 125-1 through 125-N, to begin screening patients for the clinical trial (Step 560). Clinical trial manager system 110 may electronically activate clinical sites 125 via user interface 201 linked to database 120. Additionally, clinical trial activation unit 207 may receive a notification that activated clinical sites 125 are fully certified, staffed, and stocked and are prepared to accept patients. Clinical trial activation unit 207 may send notices to begin screening patients to clinical sites 125 directly, e.g., via telephonic or postal means, or via network 140 using communication means known in the art. Subsequently, clinical trial activation unit 207 or clinical trial monitoring unit 206 may receive a notification that the screening process is underway, and units 206 and 207 may undertake the process of updating database 120 with the information. Once the clinical trial itself has begun, system environment 100 may shift to the analysis phase of the trial, which will now be described.

FIG. 6 is a flowchart of an exemplary clinical trial analysis process 600, consistent with the disclosed embodiments. Clinical trial analysis process 600, as well as any or all of the individual steps therein, may be performed by any one or more of clinical trial manager 105, clinical trial manager system 110, clinical sites 125-1 through 125-N, and clinical site systems 130-1 through 130-N. For exemplary purposes, FIG. 6 is disclosed as being performed by clinical trial manager system 110.

Clinical trial manager system 110 may receive a first set of clinical trial progress data (Step 610). The clinical trial progress data may be received from any or all of clinical sites 125. The clinical trial progress data may be received via network 140, and/or through electronic mail, facsimile means, or postal means. The clinical trial progress data may comprise, for example, raw data of how many clinical trial subjects were screened, enrolled, and randomized during a defined time period. In various embodiments, this defined time period may be daily, weekly, monthly, quarterly, yearly, or by fiscal year. Clinical trial manager system 110 may create database entries associated with the received data within database 120, and/or may update the database entries created for each clinical site 125 during clinical trial activation process 500.

In one embodiment, clinical trial manager system 110, via ratio calculator 203, may compute clinical trial ratios and projections associated with the clinical trial and with the received clinical trial progress data (Step 620). In various embodiment, these ratios may include averages of how many clinical trial subjects were screened, enrolled, and randomized over a given time period, or over a span of several time periods. For example, ratio calculator 203 may isolate clinical trial progress data received from a particular clinical site, for example, clinical site 125-1. Ratio calculator 203 may calculate ratios for each clinical site 125 based on the clinical trial progress data. For example, ratio calculator 203 may calculate how many clinical trial subjects were randomized per site per month; how many subjects were screened per site per month; how many were enrolled per site per month, etc. The ratios may be on a per site basis, may be calculated for an entire country, or for all countries in the trial. Based on the calculated ratios, ratio calculator 203 may make projections for each clinical site 125 into the future. For example, based on the pace of screening, enrollment, and randomization, ratio calculator block 203 may extrapolate into the future how many subjects should be screened, enrolled, and randomized at given timepoints. These timepoints may be daily, weekly, monthly, quarterly, yearly, by fiscal year, etc.

Clinical trial manager system 110 may store the computed clinical trial ratios and projections after they are computed (Step 630). The ratios may be stored in any or all of memory 112, database 120, or shared with other members of system environment 100 via network 140.

In one embodiment, clinical trial manager system 110 may receive a second set of clinical trial progress data (Step 640). As described above for Step 610, the clinical trial progress data may be received from any or all of clinical sites 125. The clinical trial progress data may be received via network 140, and/or through electronic mail, facsimile means, or postal means. Clinical trial manager system 110 may input the received data into database 120, and/or may update the database entries created for each clinical site 125 during clinical trial activation process 500.

In one embodiment, clinical trial manager system 110, via gap calculator 204, may perform a gap calculation process (Step 650). An example of a gap calculation process is disclosed below in connection with FIG. 7. In short, gap calculator 204 may analyze and compare the second received set of clinical trial progress data from Step 640 with the first received set of clinical trial progress data from Step 610. Gap calculator 204 may further compare the second received set of data of Step 640 with the ratios and projections calculated by ratio calculator 203 in Step 620. If the received clinical trial progress data appears to improperly bias the ratios or data, such as either unusually high or low rates of screening, enrollment, and randomization, gap calculator 204 can perform a gap calculation process to notify clinical trial manager 105 of the discrepancy, and prompt clinical trial manager 105 to modify aspects of the clinical trial to account for it.

Clinical trial manager system 110, via modeling tool 202, may perform a scenario modeling process (Step 660). An example of a scenario modeling process is disclosed below in connection with FIG. 8. In short, modeling tool 202 may review the received clinical trial progress data, the ratios calculated by ratio calculator 203, and other information and data received by clinical trial manager system 110 that may be relevant to the progress of the clinical trial. Modeling tool 202 may then model, as examples, a “best-case scenario” for the trial—e.g., how soon the trial as a whole may be completed if screening, enrollment, and randomization continue at a given pace. Similarly, a “worst-case scenario” can also be modeled, as well as a baseline scenario. The modeled scenarios can then be used as targets and metrics to give clinical trial manager 105 further insights into the progress of the trial relative to the clinical trial plan and other relevant projections.

FIG. 7 is a flowchart of an exemplary gap calculation process 700, consistent with disclosed embodiments. Gap calculation process 700, as well as any or all of the individual steps therein, may be performed by any one or more of clinical trial manager 105, clinical trial manager system 110, clinical sites 125-1 through 125-N, and clinical site systems 130-1 through 130-N. For exemplary purposes, FIG. 7 is disclosed as being performed by clinical trial manager system 110.

Clinical trial manager system 110, via gap calculator 204, may load clinical trial progress data (Step 710). In one embodiment, the loaded data may comprise the second set of clinical trial progress data received in Step 640 of clinical trial analysis process 600. Clinical trial manager system 110, via gap calculator 204, may additionally load computed clinical trial ratios and projections (Step 720). In one embodiment, the loaded ratios may comprise the clinical trial ratios computed in Step 620 of clinical trial analysis process 600. Gap calculator 204 may then compare the received clinical trial progress data with the computed clinical trial ratios and projections created by ratio calculator 203 in Step 620 of clinical trial analysis process 600 (Step 730).

Clinical trial manager system 110 may determine whether or not to implement the clinical trial plan based on the actual received set of clinical trial progress data, based on the computed clinical trial ratios and projections, or based on a mixed data model (Step 740). The mixed data model utilizes actual received trial progress data up to a specified time point, and then uses computed clinical trial ratios and projections from the specified point forward. In one embodiment, this “manual switch” is triggered automatically by an entry in database 120. Clinical trial monitoring unit 206 may also notify clinical trial manager 105 of a discrepancy between the “manual” and “automatic” data in a similar manner and may prompt action by clinical trial manager 105 via user interface 201. Clinical trial manager system 110 may, after reviewing and comparing the actual clinical trial progress data or the computed clinical trial ratios, decide to proceed with the trial operating on the actual clinical trial progress data (Step 745). In one alternative embodiment, clinical trial manager system 110 may, after reviewing and comparing the actual clinical trial progress data or the computed clinical trial ratios, decide to proceed with the trial operating on the projections based on the computed clinical trial ratios (Step 750). In another alternative embodiment, clinical trial manager system 110 may, after reviewing and comparing the actual clinical trial progress data or the computed clinical trial ratios, decide to proceed with the trial operating on a mixed data model, with the trial operating on actual clinical trial progress data up to a certain time point, then operating on the projections based on the computed clinical trial ratios (Step 755).

FIG. 8 is a flowchart of an exemplary scenario modeling process 800, consistent with disclosed embodiments. Scenario modeling process 800, as well as any or all of the individual steps therein, may be performed by any one or more of clinical trial manager 105, clinical trial manager system 110, clinical sites 125-1 through 125-N, and clinical site systems 130-1 through 130-N. For exemplary purposes, FIG. 8 is disclosed as being performed by clinical trial manager system 110.

Clinical trial manager system 110, via modeling tool 202, may load clinical trial progress data (Step 810). In one embodiment, the loaded data may comprise the first set of clinical trial progress data received in Step 610 of clinical trial analysis process 600. Clinical trial manager system 110, via modeling tool 202, may additionally load computed clinical trial ratios and projections calculated during clinical trial analysis process 600 (Step 820). In one embodiment, the loaded ratios may comprise the clinical trial ratios and projections computed in Step 620 of clinical trial analysis process 600.

Modeling tool 202 may model potential outcomes and scenarios related to the progress of the clinical trial (Step 830). Taking into account the pace of screening, enrollment, and/or randomization of a given clinical site, such as clinical site 125-1, modeling tool 202 may extrapolate a “best-case scenario” for that clinical site, assuming, for example, that in future months clinical site 125-1 will exceed its current pace of screening, enrollment, and/or randomization. Likewise, modeling tool 202 may extrapolate a “worst-case scenario” for clinical site 125-1, assuming, for example, that in future months clinical site 125-1 will fall short of its current pace of screening, enrollment, and/or randomization. Finally, modeling tool 202 may extrapolate a “baseline” scenario for clinical site 125-1, assuming, for example, that in future months clinical site 125-1 will merely maintain its current pace of screening, enrollment, and/or randomization.

These scenarios may be stored by modeling tool 202 in memory 112 within clinical trial manager system 110, or may be shared with clinical site 125-1 via network 140 and clinical site system 130-1 and/or a database linkage to database 120.

Modeling tool 202 may scale modeling of the scenarios to whatever level of granularity is required. For example, all clinical sites 125 in a given country could be modeled together. In other embodiments, all clinical sites for the entire trial could be modeled together. In some embodiments, the modeling can be performed for various time periods, such as daily, weekly, monthly, quarterly, yearly, by fiscal year, etc.

Modeling tool 202 may create outputs associated with the modeled scenarios (Step 840). These may include various outputs such as charts, graphs, tables, etc. The outputs may be stored by modeling tool 202 in memory 112 within clinical trial manager system 110, or may be shared with clinical site systems 130 or other entities inside or outside of system environment 100 via network 140 and/or a database linkage to database 120.

Clinical trial manager system 110, via any or all of user interface 201, modeling tool 202, and clinical trial monitoring unit 206, may compare clinical trial progress data over time to the modeled scenarios (Step 850). In some embodiments, this may be achieved by, for example, fitting data points derived from received clinical trial progress data onto the various graph lines modeled by modeling block 202. The results of this “best fit” analysis may be presented to clinical trial manager 105, e.g., as a prompt for decision making. In one embodiment, the actual received clinical trial progress data may match the “baseline” scenario, and no action may need to be taken at all. In another embodiment, the actual received clinical trial progress data may match the “best case scenario,” and clinical trial manager 105 may opt to take no action (and perhaps complete the clinical trial ahead of schedule) or may opt to slow the pace of screening, enrollment, and/or randomization via components of clinical trial manager system 110. In another embodiment, the actual received clinical trial progress data may match the “worst case scenario,” and clinical trial manager 105 may opt to take no action (and perhaps complete the clinical trial behind schedule) or may opt to increase the pace of screening, enrollment, and/or randomization via components of clinical trial manager system 110. These options may be part of a clinical trial monitoring process, which will now be described.

FIG. 9 is a flowchart of an exemplary clinical trial monitoring process 900, consistent with disclosed embodiments and Step 340 of clinical trial design and tracking process 300. Clinical trial monitoring process 900, as well as any or all of the individual steps therein, may be performed by any one or more of clinical trial manager 105, clinical trial manager system 110, clinical sites 125-1 through 125-N, and clinical site systems 130-1 through 130-N. For exemplary purposes, FIG. 9 is disclosed as being performed by clinical trial manager system 110.

Clinical trial manager system 110, via clinical trial monitoring unit 206, may load clinical trial progress data (Step 910). In example embodiments, the loaded data may comprise the first set of clinical trial progress data received in Step 610 of clinical trial analysis process 600, or the second set of clinical trial progress data received in Step 640 of clinical trial analysis process 600. In yet another embodiment, the loaded data may be associated with any point in time over the course of the clinical trial.

Clinical trial manager system 110, via clinical trial monitoring unit 206, may load modeled clinical trial scenarios (Step 920). In one embodiment, the modeled clinical trial scenarios are those modeled by modeling tool 202 in Step 830 of scenario modeling process 800. In another embodiment, the scenarios may have been modeled at a different time. In some embodiments, the scenarios may have been modeled by an entity other than modeling tool 202 and clinical trial manager system 110.

Clinical trial manager system 110, via any or all of user interface 201, modeling tool 202, and clinical trial monitoring unit 206, may compare clinical trial progress data to the modeled scenarios (Step 930). This comparison may be made in a manner similar to that described above in Step 850 of scenario modeling process 800.

Clinical trial monitoring unit 206 may determine whether a modification to the clinical trial is required (Step 940). Factors that clinical trial monitoring unit 206, clinical trial manager system 110, and other members of system environment 100 may consider in making the determination may include time constraints, infrastructure, budget constraints, business considerations, and any number of other factors that one skilled in the art would understand to be relevant to clinical trials and the associated businesses and industries.

If clinical trial monitoring unit 206 determines that modification to the clinical trial is not required (Step 940: NO) then clinical trial manager system 110 may determine whether to continue monitoring, or to complete the trial (Step 955). If clinical trial monitoring unit 206 determines that no further monitoring is necessary, for example if the clinical trial plan is fulfilled, or factors have made completing the plan untenable (Step 955: NO), then the process may proceed to Step 960. If clinical trial monitoring unit 206 determines that further monitoring and the trial should continue (Step 955: YES), the process begins again at Step 910, either immediately or at a time determined by clinical trial monitoring unit 206 or clinical trial manager 105.

If clinical trial monitoring unit 206 determines that modification to the clinical trial is required (Step 940: YES) then clinical trial manager system 110 may perform a trial modification process (Step 950) which will be described in greater detail below. After performing the trial modification process at Step 950, clinical trial manager system 110 via clinical trial monitoring unit 206 may determine whether to restart clinical trial monitoring process 900 and continue monitoring, or to complete the trial (Step 955). If clinical trial manager 105 determines that no further monitoring is necessary, for example if the clinical trial plan is fulfilled, or factors have made completing the plan untenable, (Step 955: NO) then the process may proceed to Step 960. If clinical trial monitoring unit 206 determines that further monitoring and the trial should continue (Step 955: YES), the process begins again at Step 910, either immediately or at a time determined by clinical trial monitoring unit 206 or clinical trial manager 105.

Clinical trial monitoring unit 206 may complete various steps associated with winding down the trial, and eventually complete the trial (Step 260). With the trial complete, clinical trial manager 105 may submit the results of the trials to various entities inside or outside of system environment 100, including the scientific press, financial consultants, government and regulatory officials, etc.

FIG. 10 is a flowchart of an exemplary trial modification process 1000, consistent with disclosed embodiments and Step 950 of clinical trial monitoring process 900. Trial modification process 1000, as well as any or all of the individual steps therein, may be performed by any one or more of clinical trial manager 105, clinical trial manager system 110, clinical sites 125-1 through 125-N, and clinical site systems 130-1 through 130-N. For exemplary purposes, FIG. 10 is disclosed as being performed by clinical trial manager system 110.

Clinical trial manager system 110, via any or all of user interface 201 and clinical trial monitoring unit 206, may review data associated with the clinical trial and with derived scenarios (Step 1010). In example embodiments, this data may comprise received clinical trial progress data, as described above in the context of clinical trial analysis process 600 and clinical trial monitoring process 900. The data may additionally comprise calculated clinical trial ratios and projections, as described above in the context of clinical trial analysis process 600. Further, the data may comprise modeled scenarios associated with the clinical trial, as described above in the context of scenario modeling process 800.

Clinical trial manager system 110 may determine whether the modification of adding additional countries is required for completion of the clinical trial (Step 1020). The determination may be made automatically, based on review of the clinical trial data in Step 1010. The determination may be made based on events that have occurred over the course of the clinical trial, such as unexpected closure of clinical sites such as clinical site 125-1, or unexpected regulatory or legislative changes in a given country associated with the trial that necessitate replacement.

If clinical trial manager system 110 determines that additional countries are required (Step 1020: YES), then clinical trial activation unit 207 may activate additional countries (Step 1025). This activation may comprise actions such as loading clinical trial planning data, sending and receiving documents associated with the clinical trial, creating entries in database 120 associated with the additional countries, and completing clinical site initiation visits. In one embodiment, the activation process may be expedited for purposes of meeting clinical trial deadlines. If clinical trial manager system 110 determines that additional countries are not required for completion of the clinical trial (Step 1020: NO), then trial modification process 1000 proceeds to Step 1030.

Clinical trial manager system 110 may determine whether additional clinical sites are required for completion of the clinical trial in any or all of the countries associated with the trial (Step 1030). The determination may be made automatically, based on review of the clinical trial data in Step 1010. The determination may be made based on events that have occurred over the course of the clinical trial, such as technical difficulties at a given clinical site 130, staff issues, or any other difficulty that may have been encountered.

If clinical trial manager system 110 determines that additional clinical sites are required (Step 1030: YES), then clinical trial activation unit 207 may activate additional clinical sites (Step 1035). This activation may include actions such as sending and receiving documents associated with the clinical trial, hiring and training staff, sending the test samples associated with the clinical trial to the sites, performing site initiation visits, etc. In one embodiment, the activation process may be expedited for purposes of meeting clinical trial deadlines. If clinical trial manager system 110 determines that additional countries are not required for completion of the clinical trial (Step 1030: NO), then trial modification process 1000 proceeds to Step 1040.

Clinical trial manager system 110 may update the clinical trial plan based on the modifications made as part of trial modification process 1000 (Step 1040). The clinical trial plan may be the same as that created in Step 470 of clinical trial planning process 400, or it may be an updated or newly created plan.

Other features and functionalities will be apparent to those skilled in the art from consideration of the specification and practice of the disclosed embodiments. For example, the processes of FIGS. 3-10 are not limited to the sequences described above. Variations of these sequences, such as the removal and/or the addition of other process steps may be implemented without departing from the spirit and scope of the disclosed embodiments.

The features and other aspects and principles of the disclosed embodiments may be implemented in various environments. Such environments and related applications may be specifically constructed for performing the various processes and operations of the disclosed embodiments or they may include a general purpose computer or computing platform selectively activated or configured by program code to provide the necessary functionality. The processes disclosed herein may be implemented by a suitable combination of hardware, software, and/or firmware. For example, the disclosed embodiments may implement general purpose machines that may be configured to execute specialty software programs that perform processes consistent with the disclosed embodiments. Alternatively, the disclosed embodiments may implement a specialized apparatus or system configured to execute software programs that perform processes consistent with the disclosed embodiments.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low level software instructions, such as for example machine code (e.g., such as that produced by a compiler) and/or high level code that can be executed by a processor using an interpreter.

Additionally, the disclosed embodiments may be applied to different types of processes and operations. Any entity undertaking a complex task may employ systems, methods, and articles of manufacture consistent with certain principles related to the disclosed embodiments to plan, analyze, monitor, and complete the task. In addition, any clinical trial management entity, governmental entity, regulatory entity, or other entity associated with any phase of a clinical trial may also employ systems, methods, and articles of manufacture consistent with certain disclosed embodiments.

Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead is defined by the appended claims in light of their full scope of equivalents.

What is claimed is:

1. A computer-implemented method of conducting a clinical trial including multiple clinical trial sites, comprising:
receiving progress data for the clinical trial;
creating database entries in a database based on the progress data;
determining projection ratios of clinical trial subjects screened, enrolled, and randomized at each clinical trial site based on the database entries;
modeling a projected outcome of the clinical trial based on the database entries and the determined ratios;
supplementing the database entries based on the progress data with additional data received from one or more of the clinical trial sites;
updating the modeled potential outcome based on the additional data; and
adjusting, via a user interface linked to the database, the number of clinical trial sites in the clinical trial based on the ratios and the updated modeled scenario.

2. The computer-implemented method of claim 1, wherein determining ratios based on the progress data further comprises:
determining the number of subjects that were screened per clinical trial site per month;
determining the number of screened subjects that were enrolled per clinical trial site per month; and
determining the number of enrolled subjects that were randomized per clinical trial site per month.

3. The computer-implemented method of claim 2, further comprising:
determining the average number of subjects that were screened by all clinical trial sites participating in the clinical trial per month;
determining the average number of screened subjects that were enrolled by all clinical trial sites participating in the clinical trial per month; and
determining the average number of enrolled subjects that were randomized by all clinical trial sites participating in the clinical trial per month.

4. The computer-implemented method of claim 2, further comprising:
determining the ratio of screened subjects to enrolled subjects;
determining the ratio of enrolled subjects to randomized subjects;
determining the number of enrolled subjects remaining to be randomized based on the modeled projected outcome;
determining the number of screened subjects remaining to enroll based on the number of subjects remaining to be randomized and the ratio of enrolled subjects to randomized subjects; and
determining the number of subjects remaining to screen based on the number of screened subjects remaining to enroll and the ratio of screened subjects to enrolled subjects.

5. A computer-implemented method of conducting a clinical trial including multiple clinical trial sites in multiple countries, comprising:
establishing a plan for the clinical trial that comprises a time period, a target number of clinical trial subjects to be randomized in the clinical trial, and a list of one or more countries in which the clinical trial will be conducted;
storing the clinical trial plan in a database;
activating, via a user interface linked to the database, one or more clinical trial sites for the clinical trial to enable the activated sites to begin screening subjects;
receiving first progress data for the clinical trial from one or more clinical trial sites;
creating database entries in a database based on the first progress data;
determining ratios based on the database entries, the ratios corresponding to the number of clinical trial subjects screened, enrolled, and randomized per activated clinical trial site per month;
receiving updated progress data from one or more of the activated clinical trial sites;
supplementing the database entries based on the updated progress data;
monitoring the clinical trial based on the first progress data and the updated progress data; and
modifying the clinical trial plan in the database based on the monitoring.

6. The computer-implemented method of claim 5, wherein monitoring the clinical trial further comprises one of:
determining that additional countries should be activated in the clinical trial; and
determining that additional clinical trial sites should be activated within a country in which the clinical trial is being conducted.

7. The computer-implemented method of claim 6, wherein modifying the clinical trial plan further comprises:
activating at least one additional country in which to conduct the clinical trial.

8. The computer-implemented method of claim 6, wherein modifying the clinical trial plan further comprises:
activating at least one additional clinical trial site within a country in which the clinical trial is being conducted.

9. The computer-implemented method of claim 5, wherein establishing a plan for the clinical trial further comprises receiving initiation parameters for the clinical trial plan, the initiation parameters comprising:
the countries in which the clinical trial will be conducted;
the number of clinical trial subjects required in each country;
the number of clinical trial sites required in each country; and
the start date for the clinical trial.

10. The computer-implemented method of claim 5, wherein activating, via a user interface, one or more clinical trial sites for the clinical trial to enable the activated sites to begin screening subjects comprises:
transmitting a clinical trial activation document to a clinical trial site;
receiving a completed clinical trial document from a clinical trial site;
performing a site initiation visit at the clinical trial site; and
commencing screening of clinical trial subjects at the clinical trial site after the document is received and the site initiation visit is completed.

11. A computer-implemented method of conducting a clinical trial including multiple clinical trial sites in multiple countries, comprising:
establishing a plan for the clinical trial, wherein the plan comprises a number of countries required for successful completion of the clinical trial and a number of clinical trial sites within each country;
storing the plan for the clinical trial in a database;
activating, via a user interface linked to the database, one or more countries required for successful completion of the clinical trial based on the clinical trial plan;
activating, via a user interface linked to the database, one or more clinical trial sites within each country based on the clinical trial plan to enable to the activated sites to begin screening subjects;
receiving progress data from one or more clinical trial sites;
creating database entries in the database based on the received progress data;
modeling a potential outcome of the clinical trial based on the database entries;
modifying the clinical trial plan based on the modeled potential outcome.

12. The computer-implemented method of claim 11, wherein modifying the clinical trial plan based on the modeled potential outcome further comprises activating, via a user interface linked to the database, at least one additional clinical trial site within at least one country associated with the clinical trial based on the clinical trial plan and the modeled potential outcome.

13. The computer-implemented method of claim 11, wherein modifying the clinical trial plan based on the modeled potential outcome further comprises deactivating, via a user interface linked to the database, at least one clinical trial site within at least one country associated with the clinical trial based on the clinical trial plan and the modeled potential outcome.

14. The computer-implemented method of claim 11, wherein modifying the clinical trial plan based on the modeled potential outcome further comprises activating, via a user interface linked to the database, at least one additional country in which the clinical trial will be conducted based on the clinical trial plan and the modeled potential outcome.

15. The computer-implemented method of claim 11, wherein modifying the clinical trial plan based on the modeled potential outcome further comprises deactivating, via a user interface linked to the database, at least one country in which the clinical trial will be conducted based on the clinical trial plan and the modeled potential outcome.

16. A system for conducting a clinical trial including multiple clinical trial sites, comprising:
a memory containing instructions; and
one or more processors configured to execute the instructions to:
receive progress data for the clinical trial;
create database entries in a database based on the progress data;
determine projection ratios of clinical trial subjects screened, enrolled, and randomized at each clinical trial site based on the database entries;
model a projected outcome of the clinical trial based on the database entries and the determined ratios;
supplement the database entries based on the progress data with additional data received from one or more of the clinical trial sites;
update the modeled potential outcome via a user interface linked to the database based on the additional data; and
adjust, via a user interface linked to the database, the number of clinical trial sites in the clinical trial based on the ratios and the updated modeled scenario.

17. The system of claim 16, wherein determining ratios based on the progress data further comprises:
determining the number of subjects that were screened per clinical trial site per month;
determining the number of screened subjects that were enrolled per clinical trial site per month; and
determining the number of enrolled subjects that were randomized per clinical trial site per month.

18. The system of claim 17, wherein the one or more processors are further configured to execute the instructions to:
determine the average number of subjects that were screened by all clinical trial sites participating in the clinical trial per month;
determine the average number of screened subjects that were enrolled by all clinical trial sites participating in the clinical trial per month; and
determine the average number of enrolled subjects that were randomized by all clinical trial sites participating in the clinical trial per month.

19. The system of claim 17, wherein the one or more processors are further configured to execute the instructions to:
determine the ratio of screened subjects to enrolled subjects;
determine the ratio of enrolled subjects to randomized subjects;
determine the number of enrolled subjects remaining to be randomized based on the modeled projected outcome;
determine the number of screened subjects remaining to enroll based on the number of subjects remaining to be randomized and the ratio of enrolled subjects to randomized subjects; and
determine the number of subjects remaining to screen based on the number of screened subjects remaining to enroll and the ratio of screened subjects to enrolled subjects.

20. A clinical trial manager system for conducting a clinical trial, comprising:
a memory containing instructions; and
one or more processors configured to execute the instructions to:
receive progress data for the clinical trial from a plurality of clinical sites;
determine one or more projection ratios of clinical trial subjects screened, enrolled, and/or randomized by at least one of the clinical sites based on the received progress data;
make a projection of the clinical trial based on the received progress data and the one or more projection ratios;
store the one or more projection ratios and the projection in the memory; and
model a scenario of the clinical trial by reviewing at least one of the one or more projection ratios or the projection stored in the memory.
